(19) United States
(12) Patent Application Publication
(10) Pub. No.: US 2006/0023145 A1
(43) Pub. Date: Feb. 2, 2006

(54) Transflective liquid crystal display

(75) Inventors: Dai-Liang Ting, Hsinchu City (TW); Chi-Jain Wen, Hsinchu City (TW); Chi-Ming Cheng, Tainan City (TW); Kuang-Lung Kuo, Jhongli City (TW); Hsiang-Ju Chuang, Hsinchu City (TW); Chia-Yi Tsai, Ilan Hsien (TW)

Correspondence Address: LIU & LIU, 444 S. FLOWER STREET SUITE 1750, LOS ANGELES, CA, 90071, US

(73) Assignee: Toppoly Optoelectronics Corp.

(21) Appl. No.: 10/902,988

(22) Filed: Jul. 30, 2004

(51) Int. Cl. G02F 1/1335

(52) U.S. Cl. 349/114

(57) ABSTRACT

A transflective liquid crystal display includes a plurality of pixel regions, each pixel region including three subpixel regions with different colors. At least one subpixel region includes a first substrate including a transmissive region and a reflective region; a second substrate disposed on the first substrate; liquid crystal interposed between the first and second substrates; and a color filter formed below the second substrate and including first and second color resists. The whole or most of the first color resist is in the reflective region and the whole or most of the second color resist is in the transmissive region, such that when shifting occurs due to assembly error, the area of the second color resist in the transmissive region remains unchanged. By means of the transflective LCD of the present invention, the chromaticity in the reflective and transmissive regions will reach the target value.

### BACKGROUND OF THE INVENTION

1. Field of the Invention

The present invention relates to a transflective liquid crystal display, and more particularly to a transflective liquid crystal display whose chromaticity in reflective and transmissive regions can be achieved substantially at a given target value that is less affected by assembly error in manufacturing processes.

2. Description of the Related Art

The liquid crystal display (LCD) is divided into three kinds: a transmissive LCD, a reflective LCD, and a transflective LCD. However, the transmissive LCD is a non-effective light converter that merely transmits about 3% to 8% of light from the backlight. Therefore, the transmissive LCD requires a backlight device having high brightness, leading to high power consumption. The reflective LCD uses ambient light for imaging, thus saving power consumption. However, the reflective LCD can be used during the day or in office where external light exists, but it cannot be used during the night or in a dim place.

Therefore, the transflective LCD has been introduced. FIG. 1 is a cross-section of a conventional transflective liquid crystal display. The transflective LCD includes upper and lower substrates 160 and 150 opposing to each other, a liquid crystal layer 180 interposed between the upper and lower substrates, and a backlight 170 under the lower substrate 150. A common electrode 162 is formed below the upper substrate 160, and a transparent transmissive electrode 164 is formed in the transmissive region t of the lower substrate 150. A reflective electrode 152 is formed in the reflective region r of the lower substrate 150 and has a light-transmitting opening 154 in the transmissive region t. A color filter layer 168 is interposed between the upper substrate 160 and common electrode 162. For a transmissive mode, light 174 emitted from the backlight 170 passes through the lower substrate 150, the transparent transmissive electrode 164, the color filter layer 168, and the upper substrate 160, and finally emerges. For a reflective mode, ambient light 172 passes through the upper substrate 160 and color filter layer 168, is incident to the reflective electrode 152, is reflected by the reflective electrode 152, passes through the color filter layer 168 and the upper substrate 160 again, and finally emerges.

As mentioned above, in the transmissive region t, light 174 emitted from the backlight 170 passes through the color filter layer 168 only once and then emerges. However, in the reflective region r, ambient light 172 passes through the color filter 168 twice to emerge. Consequently, the color saturation in the reflective region will be higher than that in the transmissive region.

In order to solve the above problem, inventors of the present invention have thought of using a lighter color resist in the reflective region and a darker color resist in the transmissive region. Thus, the color saturation of the reflective region and that of the transmissive region will become almost the same. FIG. 2 is a top view of a pixel unit of a conventional color filter layer 210, showing that the green subpixel region uses dark and light color resists. The pixel unit includes three subpixel regions: R, G, and B. The R subpixel region uses one kind of red resist 210R, the B subpixel region uses one kind of blue resist 210B, while the G subpixel region uses two kinds of green resists 211G and 212G, in which 211G has lighter color than 212G.

FIG. 3 is a cross-section taken along line 3-3′ of FIG. 2, showing the G subpixel region of the transflective liquid crystal display. Referring to FIG. 3, the transflective LCD includes a TFT array substrate S1, a color filter substrate S2, and a liquid crystal layer 300 interposed therebetween. The TFT array substrate S1 includes a lower substrate 100, a reflective electrode 191 in the green reflective region G(r), and a transparent transmissive electrode 192 in the green transmissive region G(t). The color filter substrate S2 includes an upper substrate 200, and a color filter layer 210 formed therebelow. The color filter layer 210 in the G subpixel region includes green resists 211G and 212G, in which 211G has lighter color than 212G.

Before the color filter layer 210 is actually produced, computer simulation is preformed in order to design a color filter design to conform to target value of chromaticity. It is designed that the resist 211G has the same shape as and aligns to the reflective region G(r), and the resist 212G has the same shape as and aligns to the transmissive region G(t). Then, the color filter layer is actually produced according to the color filter design. Then, the color filter substrate and the TFT array substrate are aligned and assembled. It is expected that the color saturation in the reflective region G(r) is reduced due to the lighter color resist 211G, and the color saturation in reflective and transmissive regions become identical in an ideal situation.

However, in the cell assembly process, assembly error inevitably occurs. Thus, the color filter layer 210 shifts. That is, the boundary between the resists 211G and 212G will not exactly align to the boundary between the reflective region G(r) and the transmissive region G(t) due to assembly error. Consequently, the actual chromaticity of LCD manufactured deviates from the desired target chromaticity due to assembly error in manufacturing processes. Reliance on computer simulation may not be as effective and accurate as desired. It is therefore desirable to design a LCD structure that can accommodate assembly error in manufacturing processes, to achieve the targeted chromaticity within an acceptable tolerance.

### SUMMARY OF THE INVENTION

The present invention is to solve the above-mentioned problems and provide a transflective liquid crystal display whose chromaticity in reflective and transmissive regions is achieved to the target value despite deviations due to assembly error in manufacturing processes.

The present invention provides a process for manufacturing LCD, involving a novel configuration of the color filter with respect to the transmissive and reflective regions of the LCD, which configuration can accommodate deviations due to assembly error in manufacturing processes, by compensating for such deviations, to achieve the desired target chromaticity value within a desired or acceptable manufacturing tolerance.

According to a first embodiment of the present invention, the transflective liquid crystal display includes a plurality of pixel regions, and each pixel region includes three subpixel regions with different colors. At least one subpixel region comprises: a first substrate including a transmissive region and a reflective region; a second substrate disposed on the first substrate; liquid crystal interposed between the first and second substrates; and a color filter formed below the second substrate and including first and second color resists. When the whole of the first color resist is in the reflective region, part of the second color resist is also in the reflective region, or when the second color resist is in the transmissive region, part of the first color resist is also in the transmissive region, such that when shifting occurs due to assembly error, the area of the second color resist in the transmissive region remains unchanged.

According to a second embodiment of the present invention, the transflective liquid crystal display includes a plurality of pixel regions and each pixel region includes three subpixel regions with different colors. At least one subpixel region comprises: a first substrate including a transmissive region and a reflective region; a second substrate disposed on the first substrate; liquid crystal interposed between the first and second substrates; and a color filter formed below the second substrate and including a first and a second color resists. Part of the second color resist is in the transmissive region and part in the reflective region, such that when shifting occurs due to assembly error, the second color resist increases by an increased portion and decreases by a decreased portion in the transmissive region. The increased and decreased portions compensate each other, or the areas of the increased and decreased portions are approximately equal.

The first and second color resists can be of the same color, and the first color resist can have lower color purity than the second color resist.

The reflective region can surround the transmissive region. Or, the reflective region can be adjacent to the transmissive region.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a cross-section of a conventional transflective LCD.

FIG. 2 is a top view of a pixel unit of a conventional color filter, showing that the green subpixel region uses dark and light color resists.

FIG. 3 is a cross-section taken along line 3-3′ of FIG. 2.

FIG. 4a is a top view of a color resist in a subpixel region of a transflective liquid crystal display panelaccording to a first embodiment of the present invention, and FIG. 4b is a cross-section taken along line 4-4′ of FIG. 4a.

FIG. 5 is a top view of a color resist in a subpixel region of a transflective liquid crystal display according to a second embodiment of the present invention.

FIG. 6a is a top view of a color resist in a subpixel region of a transflective liquid crystal display according to a third embodiment of the present invention.

FIG. 6b shows the condition of the transmissive region t when the second color resist 22 shifts along direction D1 by assembly error.

FIG. 6c shows the condition of the reflective region r when the second color resist 22 shifts along direction D1 by assembly error.

FIG. 7 is a top view of a color resist in a subpixel region of a transflective liquid crystal display according to a fourth embodiment of the present invention.

FIG. 8 is a top view of a color resist in a subpixel region of a transflective liquid crystal display according to a fifth embodiment of the present invention.

FIG. 9 is a top view of a color resist in a subpixel region of a transflective liquid crystal display according to a sixth embodiment of the present invention.

FIG. 10 is a top view of a six-color resist of the present invention.

FIG. 11 is a schematic diagram of a transflective LCD device, incorporating the color filter configuration in accordance with the present invention.

FIG. 12 is a schematic diagram of an electronic device incorporating a transflective LCD device that incorporates the color filter configuration in accordance with the present invention.

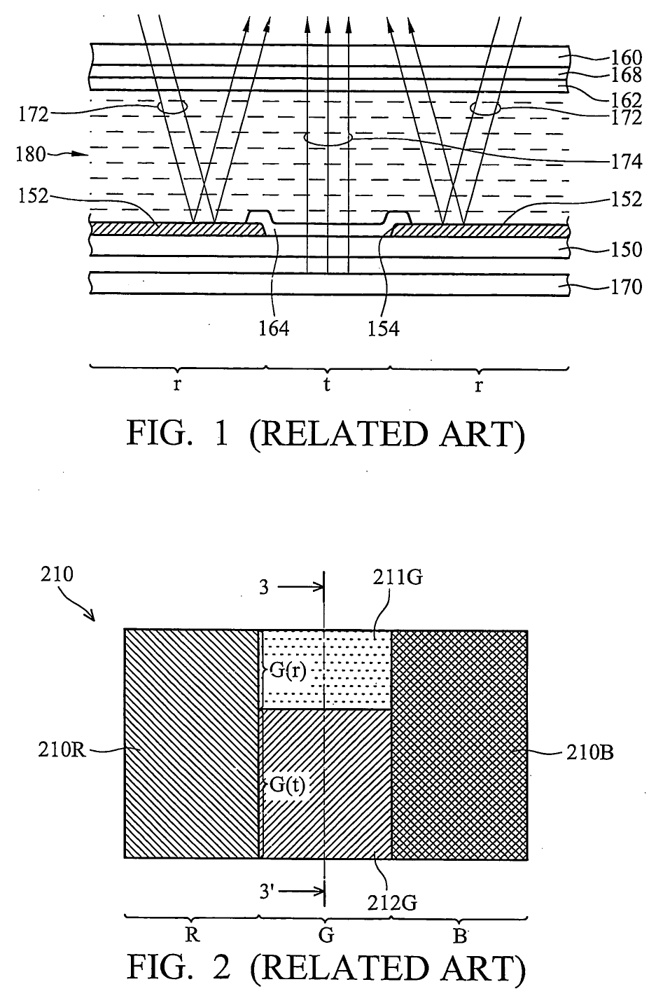

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It is noted that the description hereinbelow refers to various layers arranged on, above or overlying other layers, to describe the relative positions of the various layers. References to “on”, “above”, “overlying”, or other similar languages, are not limited to the interpretation of one layer being immediately adjacent another layer. There may be intermediate or interposing layers, coatings, or other structures present, and associated process steps present, which are not shown or discussed herein, but could be included without departing from the scope and spirit of the invention disclosed herein. Similar, references to structures adjacent, between or other positional references to other structures merely describe the relative positions of the structures, with or without intermediate structures.

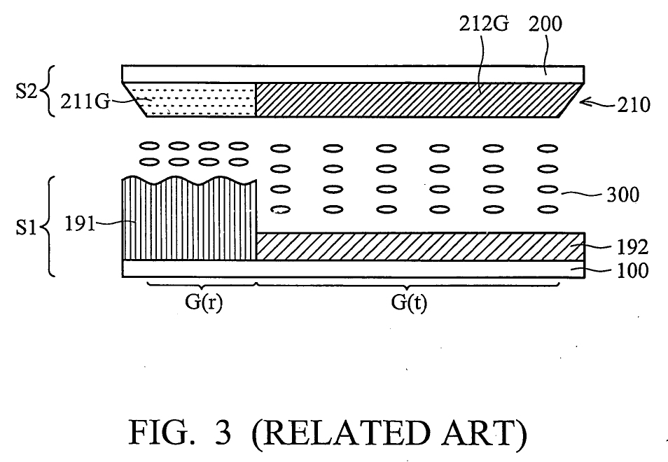

In the conventional color filter layer 210 in FIG. 3, the lighter color resist 211G is designed to have the same shape and aligns to the reflective region G(r), and the darker color resist 212G is designed to have the same shape and aligns to the transmissive region G(t) However, in the LCD cell assembly process, the color filter layer 210 is inevitably shifts due to assembly error. Consequently, the actual chromaticity of LCD manufactured deviates from the desired target chromaticity due to assembly error. Reliance on computer simulation may not be as effective and accurate as desired. Therefore, the present invention designs a special color filter design to accommodate assembly error in manufacturing processes, and to achieve the target chromaticity within an acceptable tolerance.

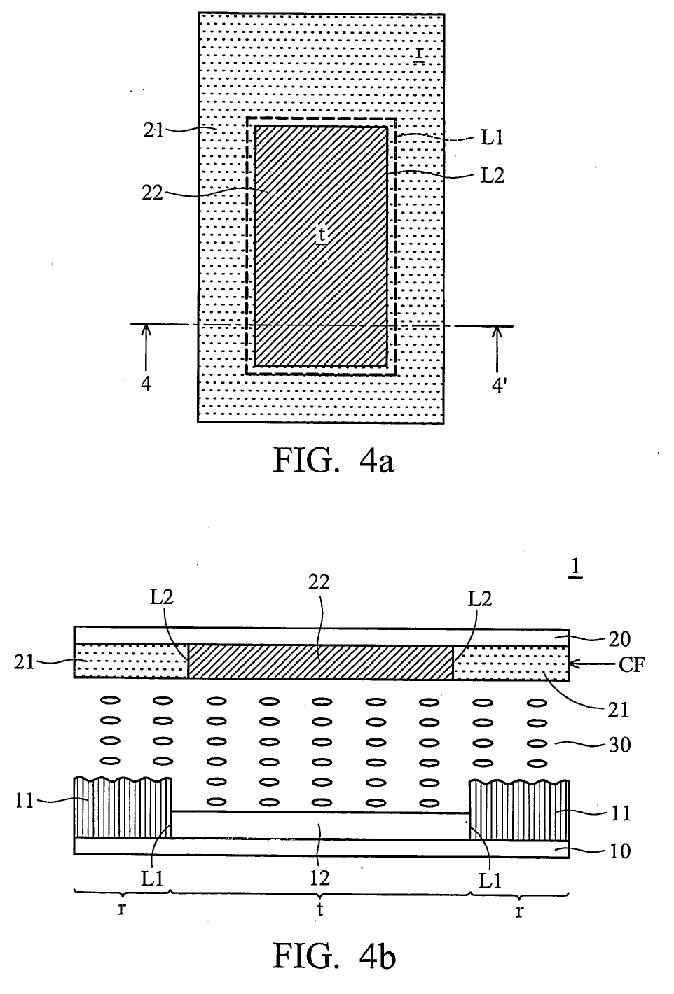

FIG. 4a is a top view of a color resist in a subpixel region of a transflective liquid crystal display panelaccording to a first embodiment of the present invention, and FIG. 4b is a cross-section taken along line 4-4′ of FIG. 4a. Refer to FIG. 4b, only showing one subpixel region of the transflective LCD panel of the present invention. The transflective LCD panel 1 includes a first substrate 10, a second substrate 20, and liquid crystal 30 interposed between the two substrates. A subpixel region of the first substrate (array substrate) 10 includes a transmissive region t and a reflective region r surrounding it. A reflective electrode 11 is in the reflective region r and a transparent transmissive electrode 12 is in the transmissive region t. A first border L1 is defined between the reflective electrode 11 and the transmissive electrode 12.

A color filter CF is formed below the second substrate 20 and faces the transmissive electrode 12 and the reflective electrode 11. In this embodiment, a color resist in a single subpixel region is taken for an example. The color filter CF includes first and second color resists 21 and 22 of the same color. The first color resist 21 has lower color purity than the second color resist 22. A second border L2 is defined between the first and second color resists 21 and 22.

As shown in FIGS. 4a and 4b, the second border L2 is located within the transmissive region t (the portion surrounded by the dotted line) of the first substrate 10. The whole of the uniform section of the second color resist 22 is in the transmissive region t, and further within the border L1. (It is noted that while FIGS. 4a and 4b illustrate the embodiment in which L2 is within L1 in both orthogonal directions, it is within the scope of the present invention that L2 may be configured to be within L1 in only one of the orthogonal directions, if compensation is desired in only such direction.) Most of the uniform section of the first color resist 21 is in the reflective region r and the rest in the transmissive region t. The designed distance between the second border L2 and the first border L1 can be suitably adjusted according to possible shifting caused by assembly error. In other words, the designed distance between L1 and L2 provides a range of tolerance to accommodate and compensate assembly error.

For example, the distance of the first and second borders L1 and L2 can be adjusted in a range of 0.05 to 10 μm. During the cell assembly process, shifting of the second color resist 22 due to assembly error is generally in a range of 0.05 to 10 m. Thus, by means of the special color filter design of FIG. 4a, even the color filter shifts by due to assembly error, since the dark color resist (the second color resist 22) is still in the transmissive region t and within the border L1, the area of the second color resist 22 in the transmissive region t of the produced panel remains substantially unchanged from the area of the second color resist in the transmissive region of the designed color filter. Thus, the chromaticity in reflective and transmissive regions remains substantially unaffected even if there is a shift in the relative position of the color resist layer and the electrode layer below as a result of deviations in manufacturing, and can meet the target chromaticity value within the manufacturing tolerance provided by the relative positioning of L1 and L2.

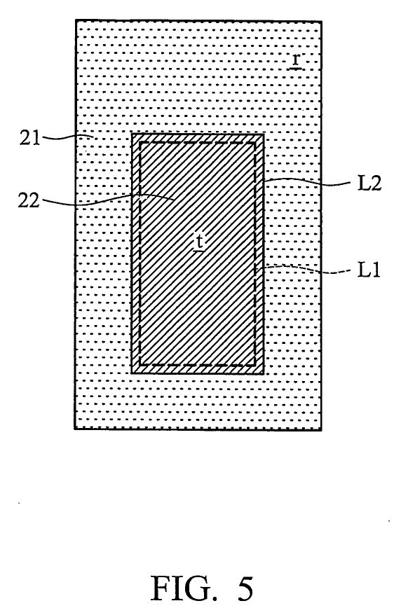

FIG. 5 is a top view of a color resist (from a design point perspective) in a subpixel region of a transflective LCD according to a second embodiment of the present invention. The portion surrounded by the dotted line is the transmissive region t of the array substrate (not shown), and the portion outside the dotted line is the reflective region r. A first border L1 (the dotted line) is defined between the reflective region r and the transmissive region t. The color resist includes a first and a second color resists 21 and 22 of the same color, and the first color resist 21 has lower color purity than the second color resist 22. A second border L2 is defined between the first and second color resists 21 and 22. As shown in FIG. 5, the second border L2 is located within the reflective region r (outside the dotted line). That is, the whole of the first color resist 21 is in the reflective region r; most of the second color resist 22 is in the transmissive region t and the rest in the reflective region r. The distance between the second border L2 and the first border L1 can be suitably adjusted according to possible shifting caused by assembly error. For example, the distance of the first and second borders L1 and L2 can be adjusted in a range of 0.05 to 10 m. Thus, when the second color resist 22 shifts by process error, since the second border L2 is still in the reflective region r, the area of the second color resist 22 in the transmissive region t (within the dotted line) remains unchanged. Thus, the chromaticity in reflective and transmissive regions remains substantially unaffected even if there is a shift in the relative position of the color resist layer and the electrode layer below as a result of deviations in manufacturing, and can meet the target chromaticity value within the manufacturing tolerance provided by the relative positioning of L1 and L2.

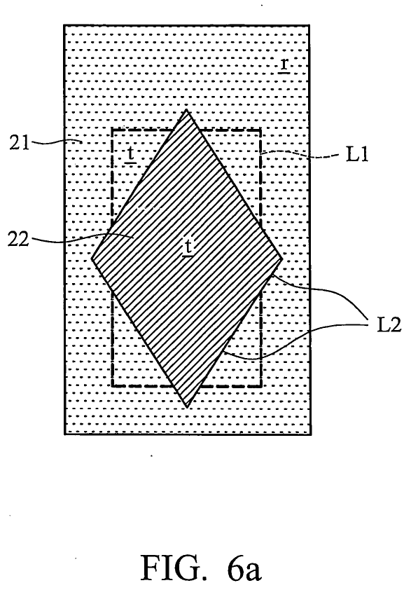

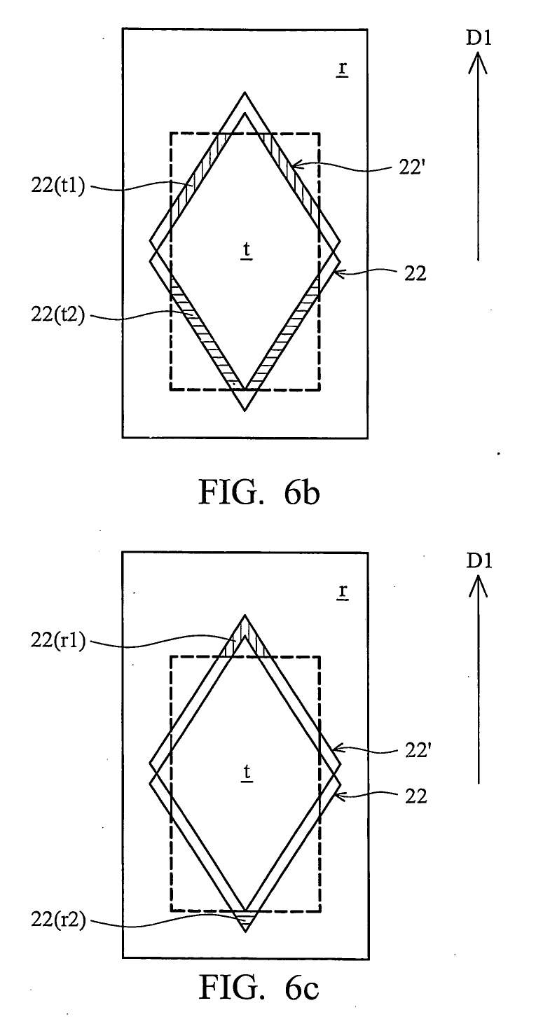

FIG. 6a is a top view (from a design point perspective) of a color resist in a subpixel region of a transflective LCD according to a third embodiment of the present invention. The portion surrounded by the dotted line is the transmissive region t of the array substrate (not shown), and the portion outside the dotted line is the reflective region r. A first border L1 (the dotted line) is defined between the reflective region r and the transmissive region t. The color resist includes a first and a second color resists 21 and 22 of the same color, and the first color resist 21 has lower color purity than the second color resist 22. A second border L2 is defined between the first and second color resists 21 and 22. As shown in FIG. 6a, part of the second border L2 is in the reflective region r (outside the dotted line) and part in the transmissive region t (within the dotted line). That is, most of the first color resist 21 is in the reflective region r and the rest in the transmissive region t; most of the second color resist 22 is in the transmissive region t and the rest in the reflective region r. In FIG. 6a, the second color resist 22 is of rhombus shape, but the shape of the second color resist is not limited to this.

FIG. 6b shows the condition of the transmissive region t when the actual second color resist 22 shifts along direction D1 caused by process error. For better understanding, the designed second color resist before assembly is labeled as 22, and the second color resist in the actually-produced panel after shifting by assembly error is labeled as 22′. When the color resist 22 shifts to the color resist 22′, the color resist 22 increases by an increased portion 22(t1) and decreases by a decreased portion 22(t2) in the transmissive region t. Thus, the increased portion 22(t1) and the decreased portion 22(t2) compensate each other, or, the increased and decreased portions 22(t1) and 22(t2) in the transmissive region can be designed to have approximately equal area. Thus, even the second color resist 22 shifts by assembly error, the area of the second color resist 22 in the transmissive region t still remains substantially unchanged, within a desired manufacturing tolerance.

FIG. 6c shows the condition of the reflective region r when the actual second color resist 22 shifts along direction D1 caused by assembly error. For better understanding, the designed second color resist before assembly is labeled as 22, and the second color resist in the actually-produced panel after shifting by assembly error is labeled as 22′. When the color resist 22 shifts to the color resist 22′, the color resist 22 increases by an increased portion 22(r1) and decreases by a decreased portion 22(r2) in the reflective region r. Thus, the increased portion 22(r1) and the decreased portion 22(r2) compensate each other, or, the increased and decreased portions 22(r1) and 22(r2) in the reflective region can be designed to have approximately equal area. Thus, even the second color resist 22 shifts by assembly error, the area of the second color resist 22 in the reflective region r still remains substantially unchanged within a desired manufacturing tolerance.

In conclusion, by means of the color filter design of FIG. 6a, the increased and decreased portions of the second color resist 22 in the transmissive region t compensate each other, and the increased and decreased portions of the second color resist 22 in the reflective region r compensate each other. Therefore, the chromaticity in the transmissive and reflective regions remains substantially unaffected and can meet the target chromaticity value.

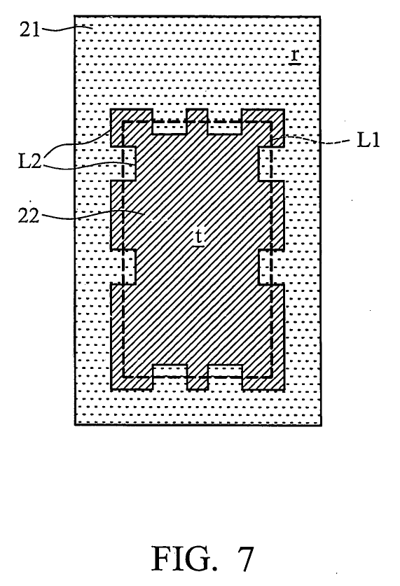

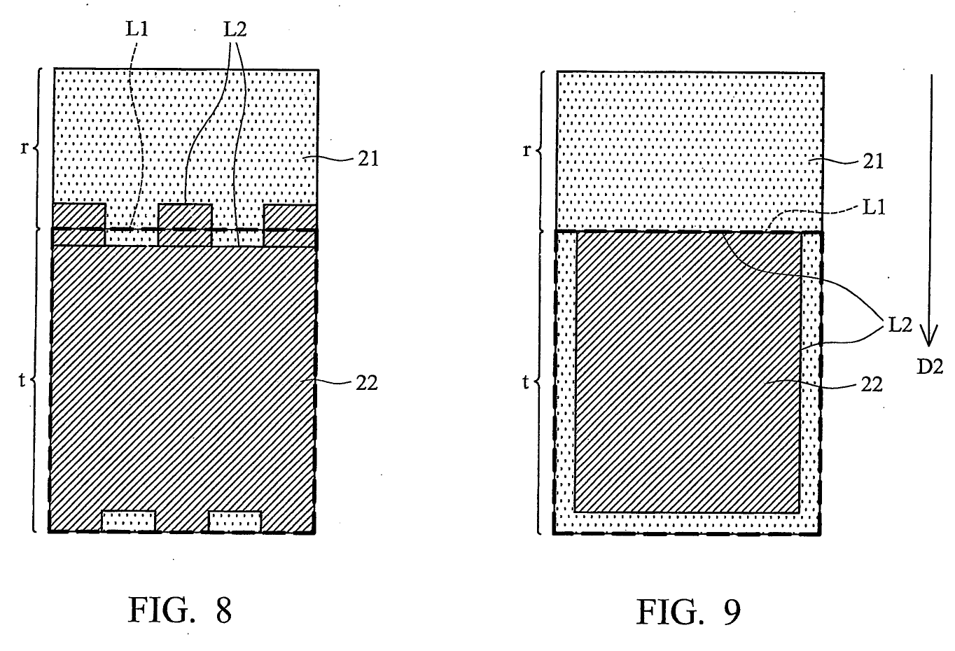

FIGS. 7 and 8 are the top views of color resists in a subpixel region of transflective LCDs according to fourth and fifth embodiments of the present invention, which are variations of FIG. 6a. In FIGS. 7 and 8, the second color resist 22 is of rectangular shape having a plurality of recesses, but the shape of the second color resist is not limited to this. For example, the second color resist 22 can be designed to be of polygon shape having a plurality of recesses.

The design principle of FIGS. 7 and 8 is similar to FIG. 6a. The common point is that the second border L2 is partly in the reflective region r and partly in the transmissive region t. Moreover, the second color resist 22 can be designed such that when the second color resist 22 shifts by assembly error, the increased portion and the decreased portion of the second color resist in the transmissive region compensate each other. Preferably, the increased and decreased portions of the second color resist in the transmissive region can have approximately equal area. Thus, when the second color resist shifts by assembly error, the area of the second color resist 22 in the transmissive region t still remains substantially unchanged.

Also, the second color resist 22 can be designed such that when the second color resist 22 shifts by assembly error, the increased portion and the decreased portion of the second color resist in the reflective region compensate each other. Preferably, the increased and decreased portions of the second color resist in the reflective region can have approximately equal area. Thus, even the second color resist shifts by assembly error, the area of the second color resist 22 in the reflective region r still remains substantially unchanged. Therefore, the chromaticity in the transmissive and reflective regions remains substantially unaffected and can meet the target chromaticity value within a desired manufacturing tolerance.

FIG. 9 is a top view of a color resist in a subpixel region of a transflective LCD according to a sixth embodiment of the present invention. The upper portion above the dotted line is the reflective region r, and the lower portion is the transmissive region t. A first border L1 is defined between the reflective region r and the transmissive region t. The color resist includes first and second color resists 21 and 22 of the same color, and the first color resist 21 has lower color purity than the second color resist 22. A second border L2 is defined between the first and second color resists 21 and 22. As shown in FIG. 9, the second border L2 is partly in the transmissive region t and partly on the first border L1. That is, most of the first color resist 21 is in the reflective region r and the rest in the transmissive region t; the whole of the second color resist 22 is in the transmissive region t. The distance between the edge of the second color resist 22 in the transmissive region t and the edge of the first color resist 21 can be suitably adjusted according to possible shifting caused by assembly error. For example, the distance between the edge of the second color resist 22 in the transmissive region t and the edge of the first color resist 21 can be adjusted in a range of 0.05 to 10 μm. Thus, when the second color resist 22 shifts along direction D2 by assembly error, since the second color resist 22 is still in the transmissive region t, the area of the second color resist 22 in the transmissive region t remains substantially unchanged. Therefore, the chromaticity in reflective and transmissive regions remains substantially unaffected and can meet the target chromaticity value within a desired manufacturing tolerance.

In the above embodiments, the color resist in a single subpixel is discussed. A pixel unit includes subpixels of different colors, e.g., red, green, and blue, and can be classified into the following three categories according to the total number of the resists used.

Four-color resist: For one color, dark and light color resists of the same color are used. For each of the other two colors, a single color resist is used. The whole or most of the light color resist is in the reflective region, and the whole or most of the dark color resist is in the transmissive region, such that when the resist shifts by assembly error, the area of the dark color resist in the transmissive region remains unchanged, or the increased and decreased portions of the dark color resist in the transmissive region compensate each other.

Five-color resist: For each of two colors, dark and light color resists of the same color are used. For another color, a single color resist is used. The whole or most of the light color resist is in the reflective region, and the whole or most of the dark color resist is in the transmissive region, such that when the resist shifts by assembly error, the area of the dark color resist in the transmissive region remains unchanged, or the increased and decreased portions of the dark color resist in the transmissive region compensate each other.

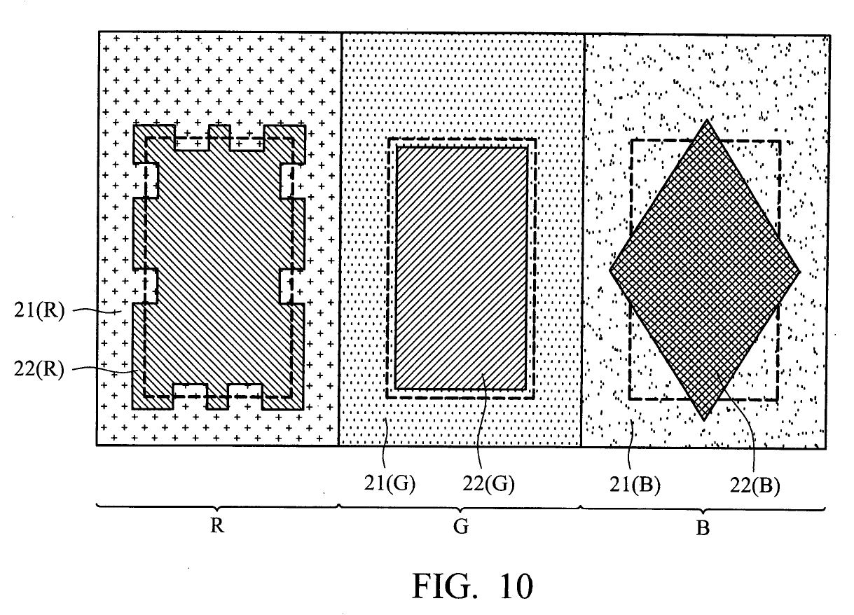

Six-color resist: For each of all three colors, dark and light color resists of the same color are used. The whole or most of the light color resist is in the reflective region, and the whole or most of the dark color resist is in the transmissive region, such that when the resist shifts by assembly error, the area of the dark color resist in the transmissive region remains unchanged, or the increased and decreased portions of the dark color resist in the transmissive region compensate each other. FIG. 10 is a top view of the six-color resist in a pixel region in accordance with one embodiment of the present invention. The six-color resist includes a red color resist in a red subpixel region R, a green color resist in a green subpixel region G, and a blue color resist in a blue subpixel region B.

The red color resist includes a first red color resist 21(R) and a second red color resist 22(R), and the first red color resist 21(R) has lower color purity than the second red color resist 22(R). The design is the same as in FIG. 7 and detailed description is omitted here.

The green color resist includes a first green color resist 21(G) and a second green color resist 22(G), and the first green color resist 21(G) has lower color purity than the second green color resist 22(G). The design is the same as in FIG. 4a and detailed description is omitted here.

The blue color resist includes a first blue color resist 21(B) and a second blue color resist 22(B), and the first blue color resist 21(B) has lower color purity than the second blue color resist 22(B). The design is the same as in FIG. 6a and detailed description is omitted here.

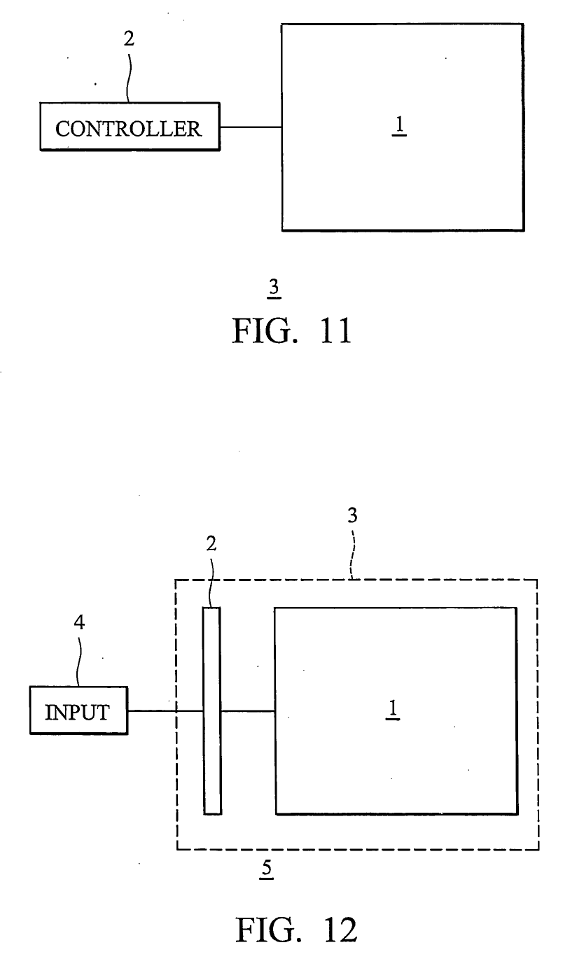

FIG. 11 is a schematic diagram illustrating a LCD device incorporating the transflective LCD panel 1 of FIG. 4b manufactured according to one embodiment of the present invention. The transflective LCD panel 1 as shown in FIG. 4b is coupled to a controller 2 to form a liquid crystal display device 3. The controller 2 can comprise a source and gate driving circuits (not shown) to control the LCD panel 1 to render image in accordance with an input.

FIG. 12 is a schematic diagram illustrating an electronic device incorporating the LCD device 3 shown in FIG. 11. An input device 4 is coupled to the controller 2 of the LCD device 3 shown in FIG. 11 to form an electronic device 5. The input device 4 can include a processor or the like to input data to the controller 2 to render an image. The electronic device 5 may be a portable device such as a PDA, notebook computer, tablet computer, cellular phone, or a display monitor device, or non-portable device such as a desktop computer.

In conclusion, the present invention uses dark and light color resists in the corresponding places of transmissive and reflective regions of the array substrate respectively. By means of the special design of the dark and light color resists, when the color resist shifts by assembly error, the area of the dark color resist in the transmissive region in the produced panel remains substantially unchanged from the area of the designed dark color resist, or the increased and decreased portions of the dark color resist in the transmissive region compensate each other. Preferably, the increased and decreased portions of the dark color resist have substantially equal area. Therefore, the influence caused by assembly error is reduced, and the chromaticity in the reflective and transmissive regions will meet the target chromaticity value.

The foregoing description of the preferred embodiments of this invention has been presented for purposes of illustration and description. Obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A transflective liquid crystal display panel including a plurality of subpixel regions, wherein at least one of the subpixel regions comprises:
a first substrate including a transmissive region and a reflective region;
a second substrate disposed above the first substrate;
liquid crystal interposed between the first and second substrates; and
a color filter formed below the second substrate and including a first and a second color resists,
wherein when the whole of the first color resist is in the reflective region, part of the second color resist is also in the reflective region, or
when the whole of the second color resist is in the transmissive region, part of the first color resist is also in the transmissive region,
such that when shifting occurs due to assembly error, the area of the second color resist in the transmissive region remains unchanged.

2. The transflective liquid crystal display panel as claimed in claim 1, wherein the first and second color resists are of the same color, and the first color resist has lower color purity than the second color resist.

3. The transflective liquid crystal display panel as claimed in claim 2, wherein the reflective region surrounds the transmissive region.

4. A transflective liquid crystal display panel including a plurality of subpixel regions, wherein at least one of the subpixel regions comprises:
a first substrate including a transmissive region and a reflective region;
a second substrate disposed above the first substrate;
liquid crystal interposed between the first and second substrates; and
a color filter formed below the second substrate and including a first and second a color resists,
wherein part of the second color resist is in the transmissive region and part in the reflective region, such that when shifting occurs due to assembly error, the second color resist increases by an increased portion and decreases by a decreased portion in the transmissive region.

5. The transflective liquid crystal display panel as claimed in claim 4, wherein the increased and decreased portions have approximately equal area.

6. The transflective liquid crystal display panel as claimed in claim 4, wherein the first and second color resists are of the same color, and the first color resist has lower color purity than the second color resist.

7. The transflective liquid crystal display panel as claimed in claim 4, wherein the reflective region surrounds the transmissive region.

8. The transflective liquid crystal display panel as claimed in claim 4, wherein the reflective region is adjacent to the transmissive region.

9. The transflective liquid crystal display panel as claimed in claim 4, wherein the second color resist is of rhombus shape.

10. The transflective liquid crystal display panel as claimed in claim 4, wherein the second color resist is of rectangular shape having a plurality of recesses or of polygon shape having a plurality of recesses.

11. A transflective liquid crystal display panel including a plurality of subpixel regions, wherein at least one of the subpixel regions comprises:
a first substrate including a transmissive region and a reflective region;
a second substrate disposed above the first substrate;
liquid crystal interposed between the first and second substrates; and
a color filter formed below the second substrate and including a first and a second color resists, wherein the whole or most of the first color resist is in the reflective region and the whole or most of the second color resist is in the transmissive region, such that when shifting occurs due to assembly error, the area of the second color resist in the transmissive region remains unchanged.

12. The transflective liquid crystal display panel as claimed in claim 11, wherein the first and second color resists are of the same color, and the first color resist has a lower color purity than the second color resist.

13. The transflective liquid crystal display panel as claimed in claim 11, wherein reflective region is adjacent to the transmissive region.

14. The transflective liquid crystal display panel as claimed in claim 11, wherein the reflective region surrounds the transmissive region.

15. A transflective liquid crystal display device, comprising:
a transflective liquid crystal display panel as claimed in claim 1; and
a controller coupled to the transflective liquid crystal display panel to control the panel to render an image in accordance with an input.

16. An electronic device, comprising:
the transflective liquid crystal display device as in claim 15; and
an input device coupled to the controller of the transflective liquid crystal display device to control the display device to render an image.

17. A transflective liquid crystal display device, comprising:
a transflective liquid crystal display panel as claimed in claim 4; and
a controller coupled to the transflective liquid crystal display panel to control the panel to render an image in accordance with an input.

18. An electronic device, comprising:
the transflective liquid crystal display device as in claim 17; and
an input device coupled to the controller of the transflective liquid crystal display device to control the display device to render an image.

19. A transflective liquid crystal display device, comprising:
a transflective liquid crystal display panel as claimed in claim 11; and
a controller coupled to the transflective liquid crystal display panel to control the panel to render an image in accordance with an input.

20. An electronic device, comprising:
the transflective liquid crystal display device as in claim 19; and
an input device coupled to the controller of the transflective liquid crystal display device to control the display device to render an image.
